(19) United States
(12) Patent Application Publication
(10) Pub. No.: US 2014/0111493 A1
(43) Pub. Date: Apr. 24, 2014

(54) DISPLAY APPARATUS AND OPTICAL INFORMATION DETECTION METHOD

(71) Applicant: Tsuneo Miyamoto, Tokyo (JP)

(72) Inventor: Tsuneo Miyamoto, Tokyo (JP)

(21) Appl. No.: 14/118,864

(22) PCT Filed: May 25, 2011
(86) PCT No.: PCT/JP2011/061983

§ 371 Date: Nov. 19, 2013

(51) Int. Cl. G09G 3/34; H05B 33/08

(52) U.S. Cl. CPC G09G 3/3406; H05B 33/0884
USPC 345/207; 345/102

(57) ABSTRACT

With this display apparatus, it is possible to switch between a mode wherein a movable shield plate closes a hole formed in a reflecting plate that reflects light from backlights which provide light from behind a liquid crystal panel that displays an image, and a mode wherein the hole is open. A color sensor arranged behind the reflecting plate detects information pertaining to the light from the backlights that has passed through the hole formed in the reflecting plate. Thus, it is possible to detect information pertaining to the light from the backlights from behind the reflecting plate with high precision, and to improve the appearance viewed from the display-surface side of the apparatus.

### TECHNICAL FIELD

The present invention relates to a display apparatus and an optical information detection method, by which information pertaining to light from a backlight (or backlight unit) is highly preciously detected at the back-face side of a reflecting plate, and appearance viewed from the display-surface side of the apparatus is improved.

### BACKGROUND ART

A liquid crystal display apparatus may detect light from a backlight, and perform feedback control based on a result of the detection.

In a liquid crystal display apparatus disclosed in Patent-Document 1, an optical sensor provided on the back-face side of a reflecting sheet detects light from a backlight, that has leaked out from the reflecting sheet.

Additionally, in a liquid crystal display unit disclosed in Patent-Document 2, a hole is provided in a reflecting sheet, and light from a backlight is detected by an optical sensor provided on the back side of the hole.

FIG. 2 is a diagram showing a general structure of a liquid crystal display apparatus based on a first background art.

In the liquid crystal display apparatus of the present example, a light guide plate 103 and a reflecting plate 104 are provided on the back-face side of a liquid crystal panel 101, and backlights 102a and 102b are provided on both sides of the light guide plate 103. Additionally, an optical sensor 105 is provided on the back-face side of the reflecting plate 104.

Light that leaks out from the reflecting plate 104 is detected by the optical sensor 105 provided on the back-face side. Based on a result of the detection of the optical sensor 105, a CPU (Central Processing Unit) 111 performs a driving control of the backlights 102a and 102b by means of an inverter 112, and a control for video signal processing by an RGB gain unit 113. Accordingly, for example, luminance or chromaticity measured at the surface of the liquid crystal panel 101 can be uniform.

FIG. 3 is a diagram showing a general structure of a liquid crystal display apparatus based on a second background art.

In comparison with the structure of the liquid crystal display apparatus shown in FIG. 2, the liquid crystal display apparatus of the present example has a feature of providing a reflecting plate 121 that has a hole 122 at a position corresponding to the optical sensor 105. By utilizing the hole 122, light from backlights 102a and 102b, that is emitted from the back face of the light guide plate 103, directly hits the optical sensor 105.

### PRIOR ART DOCUMENT

### Patent Document

Patent Document 1: Japanese Unexamined Patent Application, First Publication No. H10-222084.

### Patent Document 2: Japanese Unexamined Patent Application, First Publication No. 2009-014901.

### DISCLOSURE OF INVENTION

### Problem to be Solved by the Invention

In the above-described display apparatus as shown in FIG. 2, light that leaks from the reflecting plate 104 is detected by the optical sensor 105, which does not provide high detection accuracy.

On the other hand, the above-described display apparatus as shown in FIG. 3, which solves the above problem, also has a problem in which when being observed from the display-surface side of the apparatus, a shadow appears due to a variation (at the hole 122) in reflectance of the reflecting plate 121. Such a problem is especially pronounced in a display apparatus that has backlights 102a and 102b at both edges of the apparatus, as shown in FIG. 3.

An object of the present invention is to provide a display apparatus and an optical information detection method, which solves the above problem.

### Means for Solving the Problem

A display apparatus in accordance with the present invention includes:

a display unit that displays an image;

a backlight that illuminates the display unit from a back-face side thereof;

a reflecting plate that is provided on the back-face side of the display unit and reflects light from the backlight, where a hole is formed through the reflecting plate;

a shield plate which is switchable between a shielding mode that closes the hole formed through the reflecting plate and an open mode that opens the hole; and

an optical information detecting device that is provided on a back-face side of the reflecting plate, and that detects information pertaining to the light from the backlight, which has passed through the hole formed through the reflecting plate.

An optical information detection method in accordance with the present invention includes:

switching between a shielding mode that closes a hole formed through a reflecting plate and an open mode that opens the hole, where the reflecting plate reflects light from a backlight that illuminates a display unit, which displays an image, from a back-face side of the display unit; and

detecting, by an optical information detecting device provided on a back-face side of the reflecting plate, information pertaining to the light from the backlight, which has passed through the hole formed through the reflecting plate.

### Effect of the Invention

In accordance with the display apparatus and the optical information detection method of the present invention, information about the light from the backlight can be precisely detected on the back-face side of the reflecting plate, and simultaneously a preferable appearance viewed from the display-surface side of the display unit can be obtained.

### BRIEF DESCRIPTION OF THE DRAWINGS

FIG. 1 is a diagram showing a general structure of a liquid crystal display apparatus in accordance with an embodiment of the present invention.

FIG. 2 is a diagram showing a general structure of a liquid crystal display apparatus based on a first background art.

FIG. 3 is a diagram showing a general structure of a liquid crystal display apparatus based on a second background art.

### MODE FOR CARRYING OUT THE INVENTION

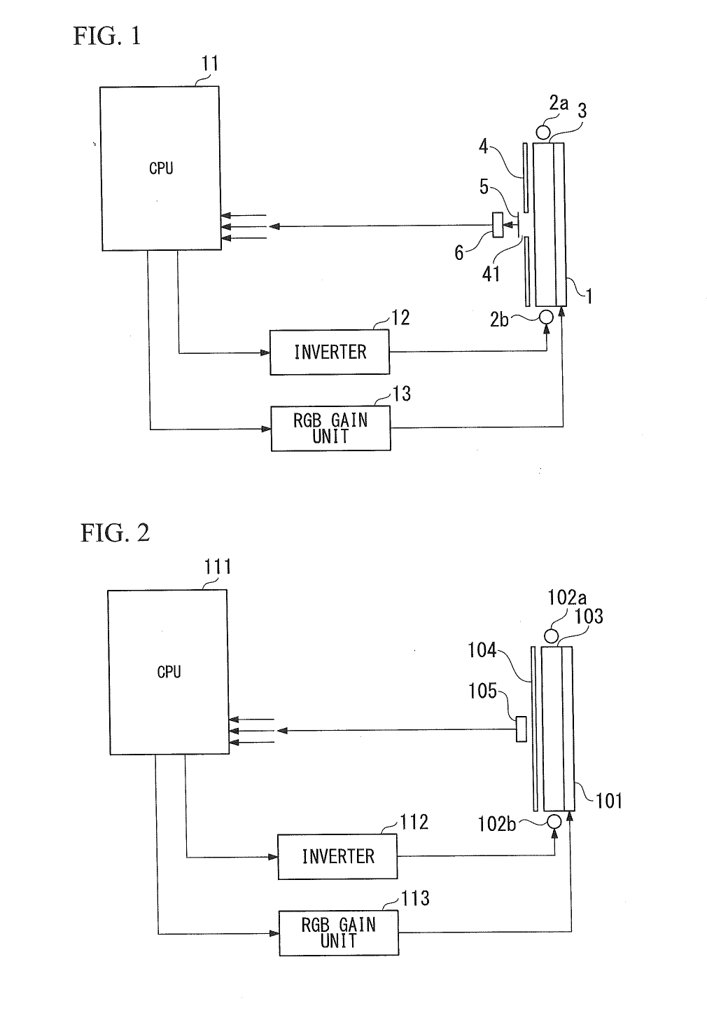

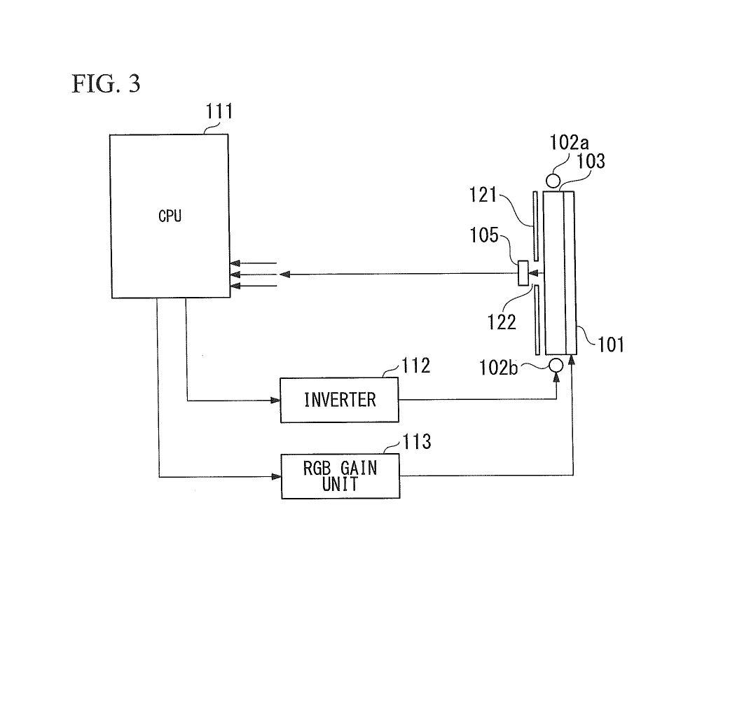

FIG. 1 is a diagram showing a general structure of a liquid crystal display apparatus in accordance with an embodiment of the present invention.

The liquid crystal display apparatus has a liquid crystal panel 1; backlights (or backlight units) 2a and 2b which function as a light source for illuminating the liquid crystal panel 1 from the back-face side thereof; a light guide plate 3 that guides light from the backlights 2a and 2b toward the plate; a reflecting plate 4 that reflects the light from the backlights 2a and 2b; a movable shield plate 5; a color sensor 6 as an example of optical sensors; a CPU 11; an inverter 12; and an RGB gain unit 13.

In FIG. 1, the liquid crystal panel 1, the backlights 2a and 2b, the light guide plate 3, the reflecting plate 4, and the movable shield plate 5 are viewed from the upper side of the apparatus.

In the liquid crystal display apparatus of the present embodiment, the light guide plate 3 and the reflecting plate 4 are provided on the back-face side of the liquid crystal panel 1, and backlights 2a and 2b are provided on both sides of the light guide plate 3. In addition, the color sensor 6 is provided on the back-face side of the reflecting plate 4. In the reflecting plate 4, a hole 41 is formed at a position corresponding to the color sensor 6 so that light can pass through the hole. Additionally, the movable shield plate 5 is provided, which makes it possible to switch between a shielding mode that closes the hole 41 in the reflecting plate 4 and an open mode that opens the hole 41. The reflecting plate 4 and the movable shield plate 5 are respectively made of materials that have the same or approximate reflectances. For example, they are made of the same material.

On the back-face side of the reflecting plate 4, the position at which the color sensor 6 is provided is not limited. For example, a center position on a flat surface of the reflecting plate 4 may be employed. Although the present embodiment utilizes one color sensor 6, another arrangement is possible in which a plurality of sets of the color sensor 6, the hole 41 of the reflecting plate 4, and the movable shield plate 5 are provided at different positions.

In addition, the present embodiment employs a preferable arrangement in which the position of the hole 41 in the reflecting plate coincides with the position of a light reception surface of the color sensor 6 so that the light through the hole 41 can directly hit the light reception surface of the color sensor 6. However, another arrangement is possible in which both positions do not coincide with each other. Even in such a case, the amount of light that hits the light reception surface of the color sensor 6 can be increased in comparison with a case in which the light through the hole 41 has no hole 41.

The size or shape of the hole 41 can be determined in any manner.

The movable shield plate 5 may be electrically or manually operated. When being electrically operated, an operator (human) may operate a specific operating part (not shown) to perform a predetermined process so as to switch, by means of the movable shield plate 5, between the shielding mode that closes the hole 41 in the reflecting plate 4 and the open mode that opens the hole 41. When being manually operated, an operator (human) manually operates the movable shield plate 5 so as to switch between the shielding mode that closes the hole 41 in the reflecting plate 4 and the open mode that opens the hole 41.

The movable shield plate 5 may have any movable structure.

In an example of electrically movable structures, it is possible to repeatedly switch between (i) the shielding mode in which the movable shield plate 5 closes the hole 41 in the reflecting plate 4 by covering the hole from the back-face side (or the display-surface side) thereof, and (ii) the open mode that opens the hole 41 by utilizing the movable shield plate 5 which slides away along a surface of the reflecting plate 4. In another example of electrically movable structures, it is possible to repeatedly switch between (i) the shielding mode in which the movable shield plate 5 closes the hole 41 in the reflecting plate 4 by being fit into the hole, and (ii) the open mode that opens the hole 41 by utilizing the movable shield plate 5 which is withdrawn from the hole. In this case, it is preferable that the movable shield plate 5, which has been withdrawn from the hole 41, further slide along a surface of the reflecting plate 4.

In an example of manually movable structures, a structure similar to an electrically movable structure may be employed, or a structure which makes it possible for the movable shield plate 5 to be detached from the liquid crystal display apparatus (of the present embodiment) itself.

Below, an example of the operation performed in the liquid crystal display apparatus of the present embodiment will be explained.

In an ordinary operation mode, the hole 41 in the reflecting plate 4 is closed by the movable shield plate 5. Accordingly, in the ordinary operation mode, when observing the apparatus from the display-surface side thereof, a shadow, that is visible when the hole 41 is open, is not visible.

On the other hand, when performing a feedback control for calibration of the display apparatus or the like, the hole 41 in the reflecting plate 4 is open by withdrawing the movable shield plate 5 so as to perform the light measurement by means of the color sensor 6. In the present embodiment, luminance or chromaticity of the backlights 2a and 2b can be measured utilizing the color sensor 6.

More specifically, the color sensor 6, that is provided on the back-face side of the reflecting plate 4, measures respective intensities of R, G, and B components of light that emits through the hole 41 in the reflecting plate 4, and outputs results of the measurement to the CPU 11. Based on the results of the measurement received from the color sensor 6, the CPU 11 performs a driving control of the backlights 2a and 2b via the inverter 12 (e.g. control of driving power), a control for video signal processing by the RGB gain unit 13. Here, the RGB gain unit 13 controls gain of the R, G, and B components in a signal of a video (image) displayed by the liquid crystal panel 1.

According to such controls, for example, luminance or chromaticity on the surface of the liquid crystal panel 1 can be uniform. In addition, only one of the driving control of the backlights 2a and 2b and the control for the video signal processing by the RGB gain unit 13 may be performed. Furthermore, another control may be performed.

Regarding the timing for starting or stopping the feedback control for the calibration or the like, a time when the CPU 11 detects that an operator (human) has operated a specific operating part (not shown) to perform a predetermined operation (that designates the starting or stopping) may be utilized. If the movable shield plate 5 is manually operated, the following arrangement is possible: the CPU 11 determines the opening or closing state of the movable shield plate 5, and according to the determined state, the CPU 11 (i) starts the relevant control operation when the closed state (shielded state) is switched to the open state (released state), and (iii) stops the control operation when the open state is switched to the closed state. Regarding the timing for stopping the control, the control may be automatically stopped when a predetermined time has elapsed from the time when the control was started.

As described above, in the liquid crystal display apparatus of the present embodiment, information about the light from the backlights 2a and 2b can be precisely detected by means of the color sensor 6 on the back-face side of the reflecting plate 4, and simultaneously a preferable appearance viewed from the display-surface side of the liquid crystal panel 1 can be obtained.

Additionally, in the liquid crystal display apparatus of the present embodiment, the liquid crystal panel 1 is employed as the display unit, the optical information detecting device (corresponding to the function of the optical information detecting unit) is implemented utilizing the function of the color sensor 6, and the control device is implemented utilizing the CPU 11 and functions of the inverter 12 and the RGB gain unit 13.

Although the present embodiment employs a liquid crystal display apparatus in which the backlights 2a and 2b are provided on both sides of the light guide plate 3, another arrangement is possible in which the present invention is applied to a liquid crystal display apparatus that has one or more backlights provided on the back face of a liquid crystal panel.

In the present embodiment, a program used to implement the function of the feedback control performed in the liquid crystal display apparatus shown in FIG. 1 is stored in a computer readable storage medium, and the program stored in the storage medium may be loaded and executed on a computer system, so as to execute the feedback control. Here, the computer system includes hardware resources such as an OS, peripheral devices, and the like.

If the computer system employs a WWW system, the computer system can provide a homepage service (or viewable) environment.

The above computer readable storage medium is a storage device, for example, a portable medium such as a flexible disk, a magneto optical disk, a ROM, or a CD-ROM, or a hard disk built in a computer system. The computer readable storage medium also includes a device for temporarily storing the program, such as a volatile storage medium in a computer system which functions as a server or client. In addition, the program may execute a part of the above-explained function. In addition, the program may also be a program by which the above-described function can be executed by a combination program of the relevant program and an existing program which has already been stored in the computer system. Furthermore, the program may be stored in a specific server in advance and be delivered via a communication network (by means of downloading or the like) in response to a request from another apparatus.

While embodiments of the present invention have been described with reference to the drawings, specific structures are not limited to the embodiments. Modifications in design can be made without departing from the scope of the present invention.

### INDUSTRIAL APPLICABILITY

The present invention can be applied to a direct viewing display apparatus utilizing a liquid crystal panel and a corresponding display method; a projection display apparatus such as a projector and a corresponding display method; or a display apparatus of another type and a corresponding display method.

### REFERENCE SYMBOLS

1 liquid crystal panel
2a backlight
2b backlight
3 light guide plate
4 reflecting plate
5 movable shield plate
6 color sensor
11 CPU
12 inverter
13 RGB gain unit
41 hole
101 liquid crystal panel
102a backlight
102b backlight
103 light guide plate
104 reflecting plate
105 optical sensor
111 CPU
112 inverter
113 RGB gain unit
121 reflecting plate
122 hole

1. A display apparatus comprising:
a display unit that displays an image;
a backlight that illuminates the display unit from a back-face side thereof;
a reflecting plate that is provided on the back-face side of the display unit and reflects light from the backlight, where a hole is formed through the reflecting plate;
a shield plate which is switchable between a shielding mode that closes the hole formed through the reflecting plate and an open mode that opens the hole; and
an optical information detecting device that is provided on a back-face side of the reflecting plate, and that detects information pertaining to the light from the backlight, which has passed through the hole formed through the reflecting plate.

2. The display apparatus in accordance with claim 1, further comprising:
a control device that starts performance of a predetermined control based on the information detected by the optical information detecting device, in response to a mode switching from the shielding mode to the open mode.

3. The display apparatus in accordance with claim 2, wherein:
the control device stops the performance of the predetermined control based on the information detected by the optical information detecting device, in response to a mode switching from the open mode to the shielding mode.

4. The display apparatus in accordance with claim 1, wherein:
the switchable mode of the shield plate is electrically or manually switched.

5. An optical information detection method comprising:
switching between a shielding mode that closes a hole formed through a reflecting plate and an open mode that opens the hole, where the reflecting plate reflects light from a backlight that illuminates a display unit, which displays an image, from a back-face side of the display unit; and
detecting, by an optical information detecting device provided on a back-face side of the reflecting plate, information pertaining to the light from the backlight, which has passed through the hole formed through the reflecting plate.

6. The display apparatus in accordance with claim 2, wherein:
the switchable mode of the shield plate is electrically or manually switched.

7. The display apparatus in accordance with claim 3, wherein:
the switchable mode of the shield plate is electrically or manually switched.
